(19) United States
(12) Patent Application Publication
(10) Pub. No.: US 2022/0274257 A1
(43) Pub. Date: Sep. 1, 2022

(54) DEVICE AND METHOD FOR CONTROLLING A ROBOT FOR PICKING UP AN OBJECT

(71) Applicant: Robert Bosch GmbH, Stuttgart (DE)

(72) Inventors: Andras Gabor Kupcsik, Boeblingen (DE); Markus Spies, Karlsruhe (DE); Philipp Christian Schillinger, Renningen (DE)

(21) Appl. No.: 17/680,861

(22) Filed: Feb. 25, 2022

(30) Foreign Application Priority Data
Mar. 1, 2021 (DE) 10 2021 201 921.8

(51) Int. Cl. B25J 9/16

(52) U.S. Cl. CPC B25J 9/1697; B25J 9/163; B25J 9/1612; B25J 9/1653

(57) ABSTRACT

A method for controlling a robot for picking up an object. The method includes: receiving a camera image of an object; ascertaining an image region in the camera image showing an area of the object where it may not be picked up, by conveying the camera image to a machine learning model which is trained to allocate values to regions in camera images that represent whether the regions show areas of an object where it may not be picked up, allocating the ascertained image region to a spatial region; and controlling the robot to grasp the object in a spatial region other than the ascertained spatial region.

### FIELD

The present invention relates to devices and methods for controlling a robot for picking up an object.

### SUMMARY

To allow for a flexible production or processing of objects by a robot, it would be desirable if a robot had the capability of handling an object regardless of the assumed position of the object in the workspace of the robot. For that reason, the robot should be able to recognize the position of the object at least to the extent that it is relevant for its pickup (e.g., grasping); in other words, it should be capable of ascertaining a pick-up pose (e.g., a grasping pose) for the object so that the robot is able to correctly align its end effector (e.g., with a grasper) and move it into the correct position. However, it may happen as a secondary condition that an object cannot be grasped in just any area, for instance because the grasper may otherwise cover a barcode or because the object might sustain damage when being grasped in a sensitive area. For that reason, it would be desirable to have control methods for a robot device for picking up an object in different positions that prevent the object from being grasped in certain areas of the object.

According to different embodiments of the present invention, a method is provided for controlling a robot for picking up an object, the method including: receiving a camera image of an object; ascertaining an image region in the camera image that shows an area on the object where it may not be picked up by conveying the camera image to a machine learning model which is trained to allocate values to regions in camera images that represent whether the region show areas of an object where it may not be picked up; allocating the ascertained image region to a spatial region; and controlling the robot to grasp the object in a spatial region other than the ascertained spatial region.

The afore-described method makes it possible to safely pick up (e.g., grasp) an object in any position of the object, and it is avoided that the object will be grasped in an area where it may not be grasped.

Different exemplary embodiments are indicated below.

Exemplary embodiment 1 is the method for controlling a robot for picking up an object in different positions, as described above.

Exemplary embodiment 2 is the method according to exemplary embodiment 1, which includes an ascertainment of the image region by training the machine learning model for the object for mapping camera images of the object onto descriptor images, and for an area of the object shown by the camera image at an image position, a descriptor image onto which a camera image is to be imaged has a descriptor value of the area of the object at the image position; obtaining descriptor values of the area on the object where it may not be picked up; mapping the camera image onto a descriptor image with the aid of the trained machine learning model; ascertaining a region in the descriptor image that has the obtained descriptor values, and ascertaining the image region as the region of the camera image at the image position that corresponds to the ascertained region in the descriptor image.

The training of such a machine learning model for ascertaining the image region showing an area on the object where it may not be picked up also allows (at a slight additional outlay) the ascertainment of the object in space and thus a suitable control of the robot for picking up the object.

Exemplary embodiment 3 is the method according to exemplary embodiment 2, in which the obtaining of descriptor values of the area on the object where it may not be picked up includes mapping a camera image in which a region is marked as a region showing an area where the object may not be picked up with the aid of a machine learning model onto a descriptor image, and selecting the descriptor values of the marked region from the descriptor image.

For example, a user may mark the region a single time (i.e., for a camera image), and regions showing an area on the object where it may not be picked up can then be ascertained via the descriptor values for all further camera images.

Exemplary embodiment 4 is the method according to exemplary embodiment 2 or 3, in which the ascertained image region is allocated to the spatial region with the aid of the trained machine learning model by ascertaining a 3D model of the object, the 3D model having a grid of vertices to which descriptor values are allocated; ascertaining a correspondence between positions in the camera image and vertices of the 3D model in that vertices having the same descriptor values as those of the descriptor image at the positions are allocated to positions; and allocating the ascertained image region to an area of the object according to the ascertained correspondence between positions in the camera image and vertices of the 3D model.

This also makes it possible to carry out the allocation of the image region to the corresponding spatial region with the aid of the machine learning model and little additional effort.

Exemplary embodiment 5 is the method according to the exemplary embodiment 1, which includes ascertaining the image region by training the machine learning model with the aid of a multitude of camera images and identifications of one or more image region(s) in the camera images showing areas where an object may not be picked up, in order to identify image regions in camera images showing areas of objects where objects are not to be picked up; and ascertaining the image region by conveying the camera image to the trained machine learning model.

If training data for such training of the machine learning model are available, e.g., images with examples of objects of barcodes that must not be covered, then this offers an opportunity for efficiently ascertaining the image region showing an area on the object where it may not be picked up.

Exemplary embodiment 6 is the method as recited in one of exemplary embodiments 1 through 5, where depth information is received for the image region of the camera image and the ascertained image region is allocated to the spatial region with the aid of the depth information.

The use of depth information supplied by an RGB-D camera, for instance, makes it possible to allocate the ascertained image region to a spatial region at a low computational expense.

Exemplary embodiment 7 is a robot control device which is set up to carry out a method as recited in one of the exemplary embodiments 1 through 6.

Exemplary embodiment 8 is a computer program, which has instructions that when executed by a processor, induce the processor to execute a method as recited in one of the exemplary embodiments 1 through 6.

Exemplary embodiment 9 is a computer-readable medium which stores instructions that when executed by a processor, induce the processor to carry out a method as recited in one of the exemplary embodiments 1 through 6.

In general, similar reference numerals in the figures relate to the same parts in all of the different views. The figures are not necessarily true to scale, the focus generally being placed more on illustrating the features of the present invention. In the following description, various aspects of the present invention are described with reference to the figures.

### BRIEF DESCRIPTION OF THE DRAWINGS

FIG. 1 shows a robot, in accordance with an example embodiment of the present invention.

FIG. 2 illustrates the training of a neural network according to one example embodiment of the present invention.

FIG. 3 illustrates a method for ascertaining a grasping pose, in accordance with an example embodiment of the present invention.

FIG. 4 illustrates the training for the method described with reference to FIG. 3 in the event that a dense object network is used.

FIG. 5 illustrates the training for the method described with reference to FIG. 3 in the event that a machine learning model is trained to recognize non-grasping areas in camera images.

FIG. 6 shows a method for controlling a robot for picking up an object, in accordance with an example embodiment of the present invention.

### DETAILED DESCRIPTION OF EXAMPLE EMBODIMENTS

The following detailed description relates to the figures that illustrate specific details and aspects of this disclosure by which the present invention is able to be implemented. Other aspects may be used, and structural, logical and electrical changes can be made without deviating from the protective scope of the present invention. The different aspects of this disclosure do not necessarily mutually exclude one another because certain aspects of this disclosure are able to be combined with one or more other aspect(s) of this disclosure in order to create new aspects.

Different examples are described in greater detail in the following text.

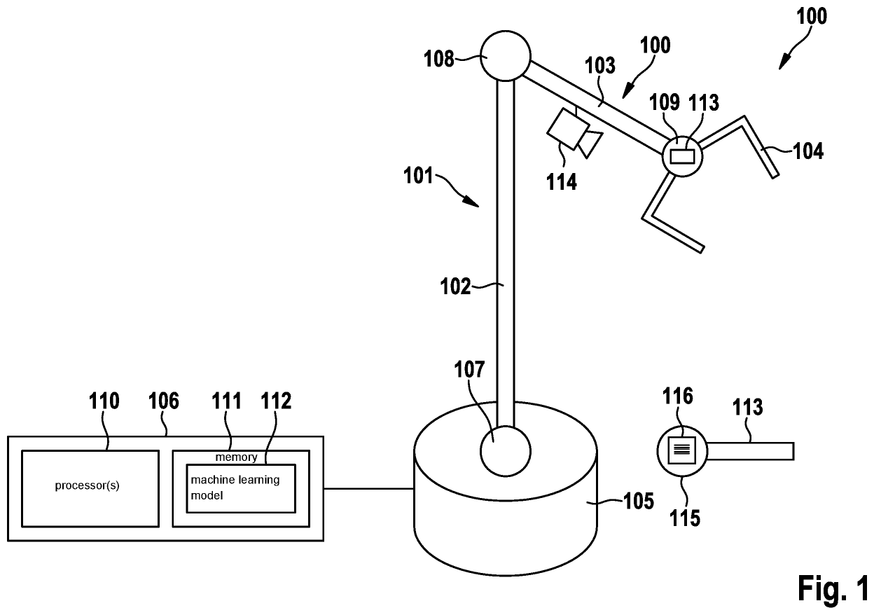

FIG. 1 shows a robot 100.

Robot 100 has a robot arm 101, for instance an industrial robot arm for handling or assembling a workpiece (or one or more other objects). Robot arm 101 includes manipulators 102, 103, 104 and a base (or holder) 105 by which the manipulators 102, 103, 104 are supported. The term ‘manipulator’ relates to the movable components of robot arm 101 whose operation allows for a physical interaction with the environment, e.g., for carrying out a task. For the control, robot 100 has a (robot) control device 106 which is configured for implementing the interaction with the environment according to a control program. The last component 104 (at the greatest distance from support 105) of manipulators 102, 103, 104 is also referred to as end effector 104 and may be equipped with one or more tool(s) such as a welding torch, a grasper instrument, a coating device or the like.

The other manipulators 102, 103 (which are situated closer to base 105) may form a positioning device so that, together with end effector 104, robot arm 101 is provided with end effector 104 at its end. Robot arm 101 is a mechanical arm, which is able to provide similar functions as a human arm (possibly with a tool at its end).

Robot arm 101 may have articulation elements 107, 108, 109, which connect manipulators 102, 103, 104 to one another and also to support 105. An articulation element 107, 108, 109 may have one or more articulation(s), which are able to provide a rotatable movement (i.e., a pivot movement) and/or a translatory movement (i.e., a displacement) for associated manipulators relative to one another. The movement of manipulators 102, 103, 104 can be initiated with the aid of actuators controlled by control device 106.

The term ‘actuator’ may be understood as a component developed to induce a mechanism or process as a reaction to its drive. The actuator is able to implement instructions (known as an activation) generated by control device 106 into mechanical movements. The actuator, e.g., an electromechanical converter, may be designed to convert electrical energy into mechanical energy as a reaction to its drive.

The term ‘control device’ may be understood as any type of logic-implemented entity which, for example, may include a circuit and/or a processor capable of executing software, firmware or a combination thereof stored on a storage medium, and/or which is able to output the instruction(s) such as to an actuator in the present example. The control device, for instance, may be configured by program code (e.g., software) in order to control the operation of a system, i.e., a robot in this example.

In the present example, control device 106 includes one or more processor(s) 110 and a memory 111 which stores program code and data used by processor 110 for the control of robot arm 101. According to different embodiments, control device 106 controls robot arm 101 on the basis of a machine learning model 112 stored in memory 111.

According to different embodiments, machine learning model 112 is configured and trained to enable robot 100 (specifically the control device) to identify areas on an object 113 where object 113 may not be grasped. For instance, object 113 may have a part 115 which is fragile (e.g., a box-shaped object could have a cutout window where it can be easily damaged), or a barcode (or QR code) 116 may be provided that end effector 104 must not cover because it is meant to be read when robot arm 101 holds object 113. By detecting the areas of object 113 where object 113 is not to be grasped (hereinafter also referred to as non-grasping areas), robot 100 is able to handle objects having such areas, which is the case in many applications.

For instance, robot 100 may be equipped with one or more camera(s) 114 which allow it to record images of its workspace. Camera 114, for example, is fastened to robot arm 101 so that the robot is able to record images of object 113 from different perspectives by moving robot arm 101 back and forth.

On the one hand, this enables robot 100 to ascertain the pose of object 113, and on the other hand, machine learning model 112 can be trained to identify regions in a camera image that show non-grasping areas. Through knowledge of pose 113 and the non-grasping areas, control device 106 is able to ascertain a grasping pose for the robot (i.e., a position and orientation of end effector 104) for grasping (or in general, for picking up) object 113, which prevents the robot from grasping a non-grasping area of the object.

Camera 114, for example, supplies images that include depth information (e.g., RGB-D images), which make it possible for control device 106 to ascertain the pose of object 113 from one or more camera image(s) (possibly from different perspectives).

However, control device 106 is also able to implement a machine learning model 112 whose output it may use to ascertain the pick-up pose (e.g., a grasping pose or also an aspiration pose) for object 113.

One example of such a machine learning model 112 for an object detection is a dense object network. A dense object network images an image (e.g., an RGB image supplied by camera 114) onto a random dimensional (dimension D) descriptor space image. However, it is also possible to use other machine learning models 112 for ascertaining the grasping pose of object 113, especially those that do not necessarily generate a “dense” feature map but merely assign descriptor values to certain points (e.g., corners) of the object.

The dense object network is a neural network which is trained, through self-monitored learning, to output a descriptor space image for an input image of an image. If a 3D model (e.g., a CAD (Computer Aided Design) model) of the object is known, which is typically the case for industrial assembly or processing tasks, then the dense object network is also trainable using monitored learning.

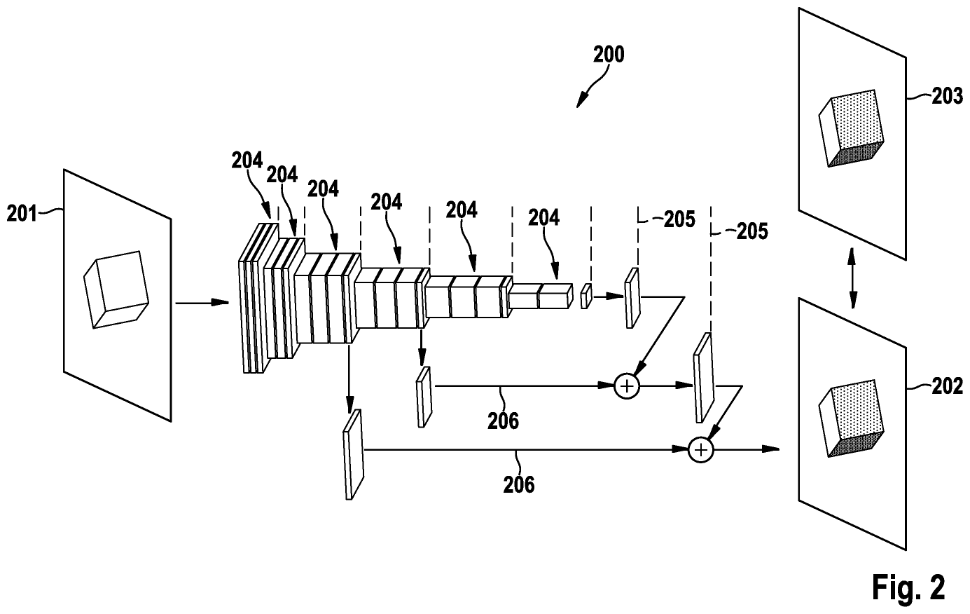

To this end, for example, a target image is generated for each camera image, that is to say, pairs of camera images and target images are generated, and these pairs of training input image and associated target image are used as training data for training a neural network as illustrated in FIG. 2.

FIG. 2 illustrates the training of a neural network 200 according to one embodiment.

Neural network 200 is a fully convolutional network, which maps an h×w×3 tensor (input image) onto an h×w×D tensor (output image).

It includes multiple stages 204 of convolutional layers, followed by a pooling layer, upsampling layers 205, and skip connections 206 for combining the outputs of different layers.

For the training, neural network 200 receives a training input image 201 and outputs an output image 202 with pixel values in the descriptor space (e.g., color components according to descriptor vector components). A training loss is calculated between output image 202 and target image 203 associated with the training input image. This may be undertaken for a stack of training input images, and the training loss is able to be averaged across the training input images, and the weights of neural network 200 are trained employing a stochastic gradient descent using the training loss. The training loss calculated between output image 202 and target image 203 is an L2 loss function, for instance (so as to minimize a pixelwise least square error between target image 203 and output image 202).

Training input image 201 shows an object, and the target image and also the output image include vectors in the descriptor space. The vectors in the descriptor space may be mapped onto colors so that output image 202 (as well as target image 203) resembles a heat map of the object.

The vectors in the descriptor space (also referred to as (dense) descriptors) are d-dimensional vectors (d amounting to 1, 2 or 3, for example), which are allocated to each pixel in the respective image (e.g., each pixel of input image 201, under the assumption that input image 201 and output image 202 have the same dimension). The dense descriptors implicitly encode the surface topology of the object shown in input image 201, invariantly with respect to its position or the camera position.

If machine learning model 112 is intended to generate camera images from descriptor images (such as a dense object network), the following procedure is used:
a. Registering camera images for an object type (e.g., a special box) from different perspectives. This may be realized with the aid of a robot on which a camera is fixed in place, or using a handheld camera.
b. Training machine learning model 112 to output descriptor images for camera images of this object type. This results in a machine learning model that allocates a descriptor value (e.g., a feature vector) to each surface point of the object, regardless of the perspective in the camera image.
c. In a representative camera image of the object, the user marks the non-grasping area or areas for the shown object.
d. By tracking the surface points of the object, marked in this way by the user, with the aid of the descriptor values, control device 106 is able to automatically identify non-grasping areas (i.e., the areas showing the non-grasping areas of the object) in newly recorded camera images.

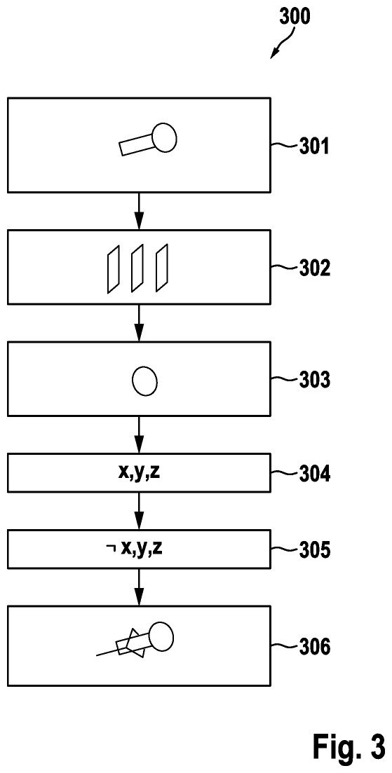

As an alternative to the above procedure, machine learning model 112 may also be trained to detect non-grasping areas directly in the camera images. For instance, the machine learning model is a convolutional network (e.g., a Mask-RCNN), which is trained to segment camera images accordingly. This is possible in instances where training images provided with identifications of non-grasping areas are available. This may be suitable if the non-grasping areas are those that are provided with barcodes, for example, for it is then possible to train machine learning model 112 to find barcodes in images. A target image, which indicates a segmentation of input camera image 201 (e.g., into barcode areas and non-barcode areas), for example, then takes the place of target image 203 with descriptor values in FIG. 3. The architecture of the neural network is able to be appropriately adapted to this task.

FIG. 3 illustrates a method for ascertaining a grasping pose, which is executed by control device 106, for instance.

A camera 114 records a camera image 301 of object 113 to be grasped, e.g., an RGB-D image. This image is conveyed to a trained machine learning model 302, e.g., a dense object net or a neural network, for the identification of non-grasping areas in camera images. From the output of the neural network, the control device ascertains non-grasping areas 303 in the camera image (either via the descriptor values allocated to the different image regions, or directly via the segmentation of the camera image output by the neural network).

In 304, control device 106 projects each non-grasping area 303 onto 3D coordinates, e.g., onto non-grasping areas of the object or also in 3D coordinates in the workspace of robot arm 101, e.g., 3D coordinates in the coordinate system of a robot cell (using the known geometry of the robot workspace and an intrinsic and extrinsic calibration of the camera). This may be realized with the aid of depth information. As an alternative, this can be achieved via the descriptor values in that the object pose that matches the viewed camera image is ascertained (so that the descriptor values appear at the correct locations in the camera image or the associated descriptor image). To this end, the associated PnP (perspective-n-point) problem is solved.

In 305, the control device then excludes the ascertained 3D coordinates from the possible grasping poses (i.e., grasping poses that would grasp the object in areas that overlap with the ascertained 3D coordinates).

The control device (e.g., as a grasp-planning module) then ascertains a safe grasping pose 306 in which the non-grasping areas of the object will not be grasped.

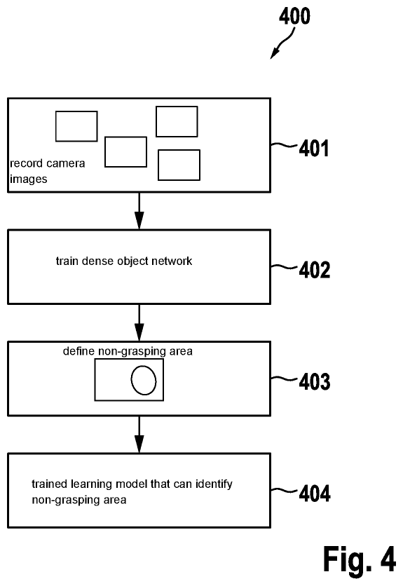

FIG. 4 illustrates the training for the method described with reference to FIG. 3 in the event that a dense object network (or generally a machine learning model that maps camera images onto descriptor images) is used.

In 401, camera images from different perspectives of the object type to be grasped are recorded.

In 402, using the camera images, the dense object network is trained to image camera images onto descriptor images (according to an allocation of surface points (e.g., vertices) of the object to descriptor values, which may be predefined for monitored learning or be learned simultaneously for unsupervised learning). Herein, as usual in connection with 3D models, the grid points of a 3D object model are denoted as ‘vertices’ (singular: ‘vertex’).

In 403, a user defines the non-grasping area in one of the images, for instance by indicating a rectangular frame of the non-grasping area with the aid of the mouse.

This results in a trained learning model 404 which can identify the non-grasping area that the user indicated by defining the non-grasping area in the camera image in newly recorded camera images regardless of the perspective.

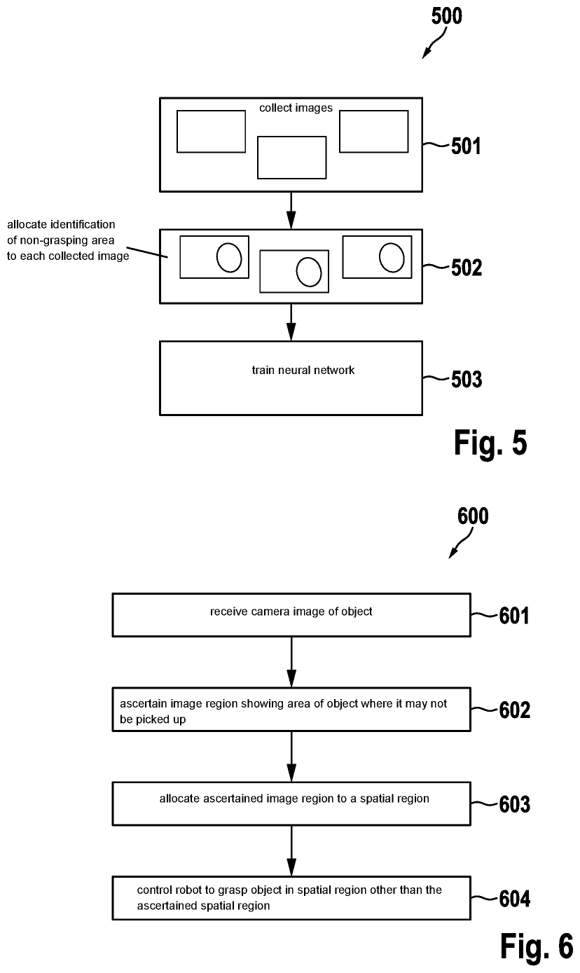

FIG. 5 illustrates the training for the method described with reference to FIG. 3 in the event that a machine learning model is trained (in a monitoring manner) to identify non-grasping areas (directly) in camera images, that is to say, to segment an input camera image accordingly.

In 501, images which include examples of non-grasping areas (e.g., barcodes) are collected. In 502, an identification of the non-grasping area in the image is allocated to each one of the collected images (e.g., a corresponding segmentation image). In 503, a neural network for detecting non-grasping areas in newly recorded camera images is trained with the aid of the training data generated in this way.

In summary, according to different embodiments, a method as illustrated in FIG. 6 is provided.

FIG. 6 shows a flow diagram for a method for controlling a robot for picking up an object, e.g., carried out by a control device 106.

In 601, a camera image of an object is received (e.g., recorded by a camera).

In 602, an image region in the camera image showing an area of the object where it may not be picked up is ascertained. This is accomplished by conveying the camera image to a machine learning model which is trained to allocate values to regions in camera images that indicate whether the regions show points of an object where it may not be picked up.

These values, for example, could be descriptor values or also values that indicate a segmentation of the camera image (e.g., generated by a convolutional network trained for a segmentation).

In 603, the ascertained image region is allocated to a spatial region.

In 604, the robot is controlled to grasp the object in a spatial region other than the ascertained spatial region.

In other words, according to different embodiments, a region in a camera image is identified with the aid of a machine learning model (e.g., by a neural network) that shows an area of an object where the object may not be picked up (grasped or aspirated). This region of the camera image is then mapped onto a spatial region, for instance via depth information or by solving a PnP problem. This spatial region (i.e., the area of the object in space shown in the identified region) is then excluded from being picked up, or in other words, grasping poses that would grasp (or aspirate) the object in this area, for example, are excluded from the set of grasping poses from which a planning software module, for example, makes a selection.

The term ‘pick up’, for instance, denotes the grasping by a grasper. However, it is also possible to use other types of holding mechanisms such an aspirator for aspirating the object. In addition, ‘pick up’ need not necessarily be understood to indicate that the object alone is moved; it is also possible, for instance, that a component on a larger structure is taken and bent without separating it from the larger structure.

The machine learning model is a neural network, for example. However, other appropriately trained machine learning models may be used as well.

According to different embodiments, the machine learning model allocates descriptors to pixels of the object (in the image plane of the respective camera image). This may be seen as an indirect coding of the surface topology of the object. This connection between descriptors and the surface topology may be explicitly undertaken by rendering in order to image the descriptors onto the image plane. It should be noted that descriptor values in areas (i.e., points that are not vertices) of the object model are able to be determined by interpolation. For instance, if an area is given by three vertices of the object model with their respective descriptor values y₁, y₂, y₃, then the descriptor value y is able to be calculated at any point of the area as a weighted sum of these values w₁·y₁+w₂·y₂+w₃·y₃. In other words, the descriptor values are interpolated at the vertices.

According to different embodiments, the machine learning model is trained using training data image pairs, each training data image pair having a training input image of the object and a target image, the target image being generated by projecting the descriptors of the vertices visible in the training input image onto the training input image plane according to the position of the object in the training input image.

According to another embodiment, the machine learning model is trained using training data images, each training data image as ground truth having an identification of the regions of the training data image that show areas of the object that may not be grasped.

The images together with their associated target images or the identifications are used for the monitored training of the machine learning model.

The method from FIG. 6 is able to be executed by one or more computer(s) equipped with one or more data processing device(s). The components of the data processing device may be realized by one or more circuit(s). In one embodiment, a ‘circuit’ is to be understood as any unit that implements a logic and which may be either hardware, software, firmware or a combination thereof. Thus, a ‘circuit’ in one embodiment may be a hard-wired logic circuit or a programmable logic circuit such as a programmable processor. However, a ‘circuit’ may also be understood as a processor which executes software, e.g., any type of computer program such as a computer program in programming code for a virtual machine. In one embodiment, a ‘circuit’ may be understood as any type of implementation of the functions described herein.

The camera images, for example, are RGB images or RGB-D images, but could also be other types of camera images such as thermal images. The grasping pose, for instance, is ascertained to control a robot for picking up an object in a robot cell (e.g., from a box), for instance for assembling a larger object from partial objects, the moving of objects, etc.

Although specific embodiments have been illustrated and described herein, one of average skill in the arts should recognize that a multitude of alternative and/or equivalent implementations may be substituted for the specifically shown and described embodiments without deviating from the protective scope of the present invention. This application is meant to cover all adaptations or variations of the embodiments specifically described herein.

1-9. (canceled)

10. A method for controlling a robot for picking up an object, comprising the following steps:
receiving a camera image of an object;
ascertaining an image region in the camera image that shows an area of the object where the object may not be picked up, by conveying the camera image to a machine learning model that is trained to allocate values to regions in camera images that represent whether regions show areas of the object where the object may not be picked up;
allocating the ascertained image region to a spatial region; and
controlling the robot to grasp the object in a spatial region other than the ascertained spatial region.

11. The method as recited in claim 10, further comprising:
ascertaining the image region by training, for the object, the machine learning model for mapping camera images of the object onto descriptor images, and for an area of the object shown by the camera image at an image position, a descriptor image onto which a camera image is to be mapped has a descriptor value of the area of the object at the image position;
obtaining descriptor values of the area of the object where it may not be picked up;
mapping the camera image onto a descriptor image using the trained machine learning model;
ascertaining a region in the descriptor image that has the obtained descriptor values; and
ascertaining the image region as the region of the camera image at the image position that corresponds to the ascertained region in the descriptor image.

12. The method as recited in claim 11, wherein the obtaining of descriptor values of the area on the object where it may not be picked up includes mapping a camera image in which an area is marked showing an area where the object may not be picked up, using the machine learning model, onto a descriptor image, and selecting the descriptor values of the marked regions from the descriptor image.

13. The method as recited in claim 11, wherein the ascertained image region is allocated to the spatial region using the trained machine learning model by:
ascertaining a 3D model of the object, the 3D model having a grid of vertices to which descriptor values are allocated;
ascertaining a correspondence between positions in the camera image and vertices of the 3D model in that vertices having the same descriptor values as those of the descriptor image at the positions are allocated to positions; and
allocating the ascertained image region to an area of the object according to the ascertained correspondence between positions in the camera image and vertices of the 3D model.

14. The method as recited in claim 10, further comprising:
ascertaining the image region by training the machine learning model using a multitude of camera images and identifications of one or more image region(s) in the camera images showing areas where an object may not be picked up, to identify image regions in camera images showing areas of objects where the objects may not be picked up; and
ascertaining the image region by conveying the camera image of the object to the trained machine learning model.

15. The method as recited in claim 10, wherein depth information is received for the image region of the camera image and the ascertained image region is allocated to the spatial region using the depth information.

16. A robot control device configured to control a robot for picking up an object, the robot control device configured to:
receive a camera image of an object;
ascertain an image region in the camera image that shows an area of the object where the object may not be picked up, by conveying the camera image to a machine learning model that is trained to allocate values to regions in camera images that represent whether regions show areas of the object where the object may not be picked up;
allocate the ascertained image region to a spatial region; and
control the robot to grasp the object in a spatial region other than the ascertained spatial region.

17. A non-transitory computer-readable medium on which are stored instructions for controlling a robot for picking up an object, the instructions, when executed by a computer-causing the computer to perform the following steps:
receiving a camera image of an object;
ascertaining an image region in the camera image that shows an area of the object where the object may not be picked up, by conveying the camera image to a machine learning model that is trained to allocate values to regions in camera images that represent whether regions show areas of the object where the object may not be picked up;
allocating the ascertained image region to a spatial region; and
controlling the robot to grasp the object in a spatial region other than the ascertained spatial region.
